(19) United States
(12) Patent Application Publication
(10) Pub. No.: US 2011/0042151 A1
(43) Pub. Date: Feb. 24, 2011

(54) WEIGHT DETECTING HANDLE TO BE ATTACHED TO A CONTAINER

(75) Inventor: Carlos De La Fe Dahlin, Stockholm (SE)

Correspondence Address: YOUNG & THOMPSON, 209 Madison Street, Suite 500, Alexandria, VA, 22314, US

(73) Assignee: CLEAVER WAYS AB, Stockholm (SE)

(21) Appl. No.: 12/919,508

(22) PCT Filed: Feb. 27, 2009
(86) PCT No.: PCT/SE09/00109

§ 371 Date: Oct. 29, 2010

(30) Foreign Application Priority Data
Feb. 29, 2008 (SE) 0800493-9

(51) Int. Cl. G01G 23/00

(52) U.S. Cl. 177/245

(57) ABSTRACT

A handle (17) which can be secured in the top (9) of a package, especially the top (9) of a bag-in-box package. When the package is picked up by the handle, the handle detects the weight of the package, which is then presented to the handle translated into remaining quantity of liquid or quantity of liquid drained from the package.

### TECHNICAL FIELD OF THE INVENTION

The present invention concerns a weight-detecting handle designed to be attached to a package, preferably a bag-in-box package.

### PRIOR ART

It is desirable to be able to determine how much of the contents remain in a package. For example, it is desirable to know how much wine remains in a bag-in-box package. One way to determine the remaining amount of liquid is to weigh the package.

### OBJECTS AND FEATURES OF THE INVENTION

A primary object of the present invention is to show a weight-detecting handle of the kind defined in the introduction, wherein the handle detects the weight of the package when the package is lifted by the handle.

A further object of the present invention is that the weight of the package is presented in connection with the handle converted to the remaining quantity of liquid in the package or quantity of liquid drained from the package.

Yet another object of the present invention is that force transmitting means forming part of the handle, bear against the underside of the top of the package.

At least the primary object of the present invention is realised by means of a weight-detecting handle having the features defined in the following independent patent claim 1. Preferred embodiments of the invention are defined in the dependent patent claims.

### BRIEF DESCRIPTION OF THE DRAWINGS

A number of embodiments of the invention shall be described hereafter, reference being made to the enclosed drawings, where:

FIG. 1A-C show three different views of a weighing handle with bladder and tube. The figure shows the section of the handle situated underneath the top;

FIG. 2A shows the handle when it is not lifting the package;

FIG. 2B shows the handle when it is lifting the package;

FIG. 3A-D shows, in sequence, how the handle is brought down through the top of the package;

FIG. 4A shows the handle without bladder and tube;

FIG. 4B shows the bladder and tube. The placement of the handle and bladder/tube in FIGS. 4A and 4B show how the bladder with tube is designed to be affixed to the handle, i.e., the tube is threaded from below through the opening in the end of the handle;

FIG. 4C shows a further view of the bladder and tube;

FIG. 5 shows a packaging which is a bag-in-box package, consisting of a rigid outer casing that contains a flexible bag, containing a liquid which can be emptied from the tap. A handle is attached to the top of the package;

FIG. 6A-B show two views of the handle, wherein the top side of the handle, the part of the handle located above the top of the package, is provided with a marking. In the figure, the marking has the shape of four bottles. Note that the bottles do not need to have the same size or shape;

FIG. 7A-B show two views of the handle. The handle is secured in the top of a bag-in-box package, which is part of the rigid outer casing of the package. In FIGS. 7A and 7B, the bladder and tube have been left out. The plane view per FIG. 7A shows the opening through which the tube will run, as well as a recess designed to receive the tube. The tube then runs for along the top side of the handle;

FIG. 8A-D show an embodiment where the cavity is closed and contains a gas, preferably air. Bubbles are formed from the wall of the tube, and the bubbles can assume two positions, namely, a retracted position and an expanded position;

FIG. 9 shows a weight-detecting handle. Above the top of the bag-in-box package, the handle extends along the top. The force-transmitting means extends along the underside of the top, and turns in the plane of the paper;

FIG. 10 shows a weight-detecting handle. Above the top of the bag-in-box package, the handle extends along the top. The force-transmitting means extends along the underside of the top, and turns in the cross sectional plane;

FIG. 11 shows a weight-detecting handle. Above the top of the bag-in-box package, the handle extends along the top. The force-transmitting element extends, however, along the underside of the top, transversely to the lengthways dimension of the handle, i.e., the force-transmitting element turns in the same plane as the cross section in the figure;

FIG. 12 shows a handle that weighs a package, wherein two views are shown and for two different package weights;

FIG. 13 shows a plane view of a bag-in-box package. The handle is shown cut away. The figure shows a number of force-transmitting elements by broken lines, the force-transmitting element forming contact surfaces with the underside of the top of the bag-in-box package;

FIG. 14A-B show a handle in cut away view. A cavity is shown, comprised in the handle;

FIG. 15A-B show a cross section of part of a handle, where a bladder is deformed when the package is lifted by the handle, so that the coloured liquid rises in a tube; and

FIG. 16A-B show a section of a tube whose wall forms a bubble. A pointer is attached to the bubble.

### A FIRST PREFERRED EMBODIMENT OF THE INVENTION

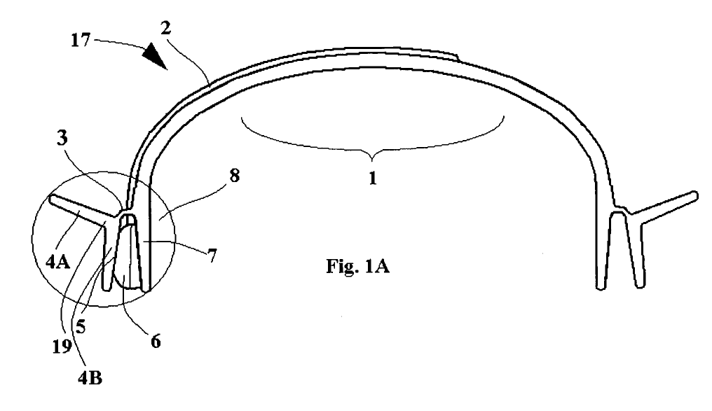

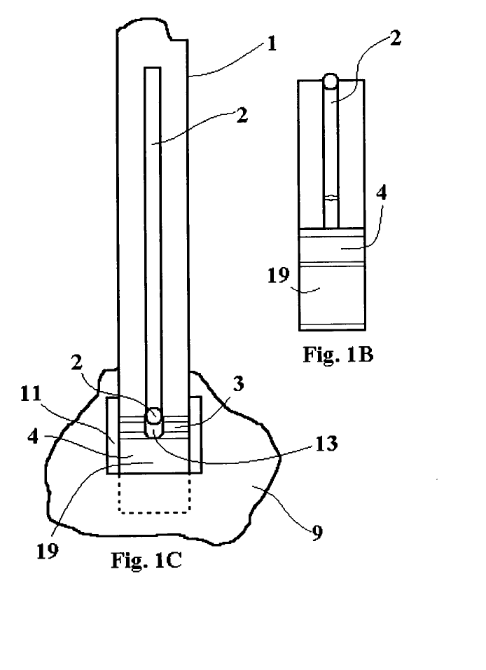

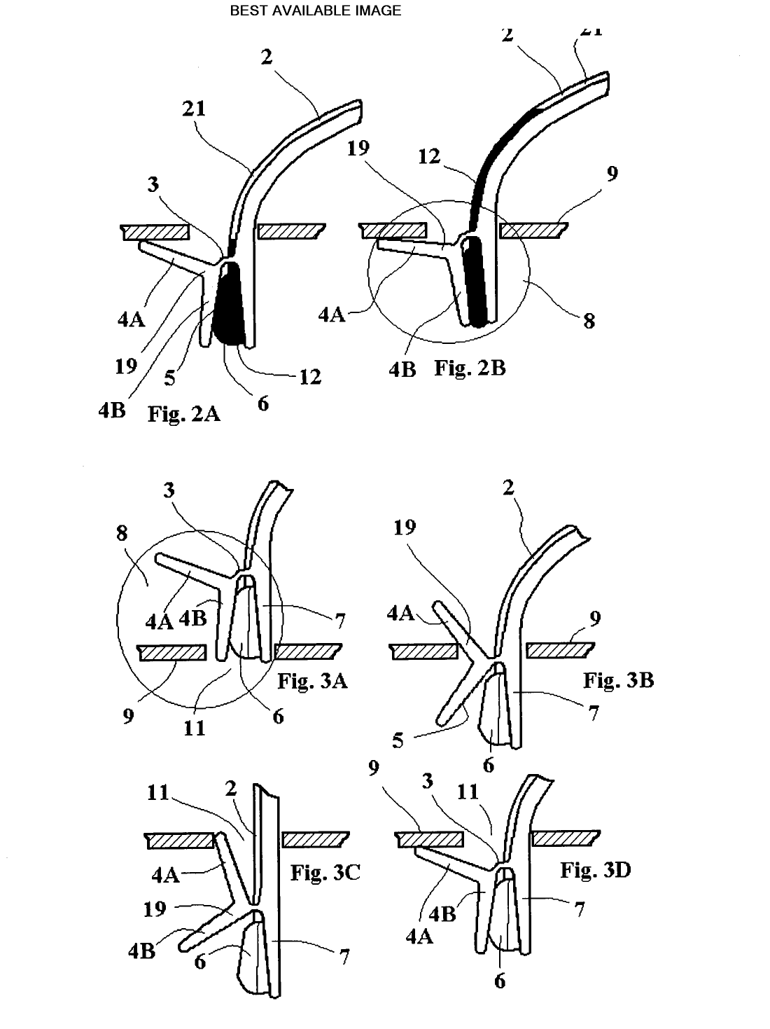

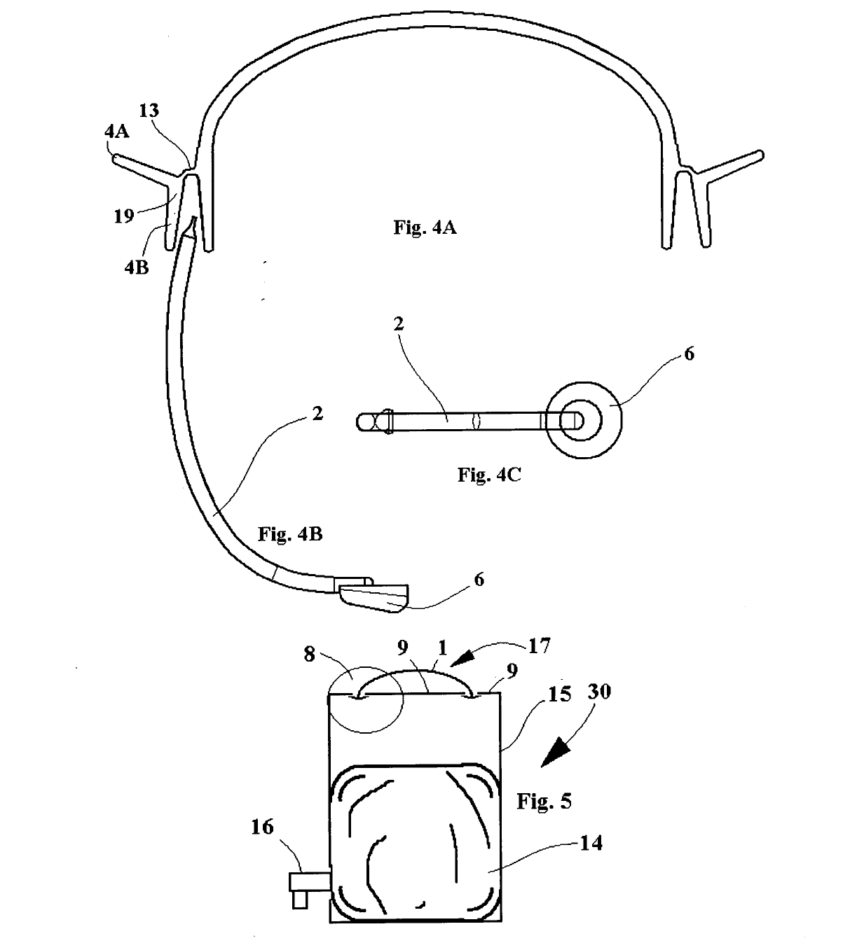

FIG. 1A-1C show three different views of a weight-detecting handle. The handle consists of a section 1 intended to be taken by the hand, a boomerang-like force-transmitting element 19 which is able to turn about a joint 3, which in the figures is constituted by a weakened region 3, a bladder 6 and a tube 2 which runs from the upper part of the bladder along the top side of the handle. The bladder 6 in this embodiment contains a coloured liquid 12, see FIGS. 2A and 2B.

The force-transmitting element 19 comprises a first wing 4A and a second wing 4B, whereby these wings 4A, 4B, in the embodiment shown, define between them an obtuse angle. The wings 4A, 4B together define a boomerang-like shape. The second wing 4B comprises a surface 5 resting against the bladder 6. The handle also comprises a bearing element 7.

The section of the handle situated in connection with the top of the package, with which the handle will interact, is designated as 8 in FIG. 1A. The invention is primarily directed to the section 8.

FIGS. 2A and B show schematically how the handle can be attached to the top of the package, especially the top 9 of a bag-in-box package. In FIG. 2B one can see how the force-transmitting element 19 has turned anticlockwise, and how the bladder 6 has been compressed. In FIGS. 2A and 2B, one can see how the coloured liquid 12 rises when the handle 17 is picked up. Since when the package is picked up the level of rise is read against a marking on the top side of the handle 17, one can determine the remaining quantity of liquid in the package.

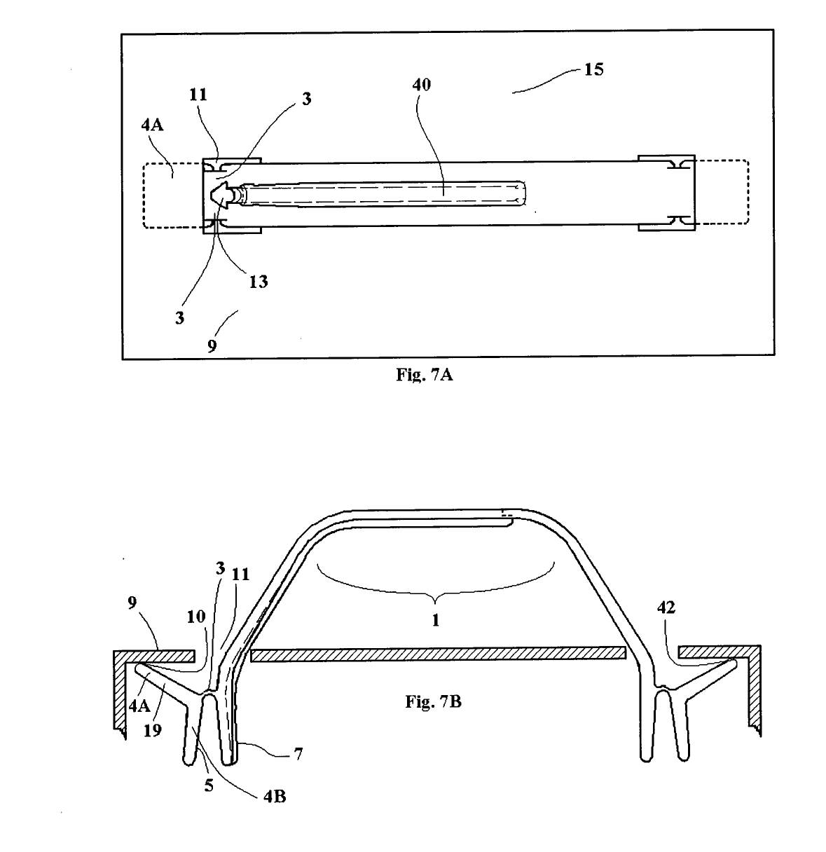

When the handle 17 is picked up, the package 30 is borne by the two contact surfaces 10, 42, see for example FIG. 7B, where one contact surface 10 is formed between the first wing 4A and the inside of the box top 9. The vertical force exerted by the top 9 via the contact surface 10 on the first wing 4A when the package is lifted is mainly proportional to the package weight. This means that also the pressure exerted by the surface 5, see FIG. 2B, on the bladder 6 when the package is picked up remains basically proportional to the package weight.

In this embodiment, the enclosed cavity 6, 2 formed by the bladder 6 and tube 2 contains a coloured liquid 12 and a gas 21, preferably air. For this embodiment, the bladder 6 is made thin, so that basically no material stresses are experienced by the bladder 6 when the package 30 is picked up. For this embodiment, therefore, the weakened region 3 is thin so that it basically experiences no material stresses when the element 19 turns, as a result of picking up the package. This means that the coloured liquid 12 will rise when the package is being weighed in the handle, until the increasingly compressed gas 21 reaches a pressure sufficient to create an equilibrium. The more the package weighs, the more the gas 21 is compressed and the higher the coloured liquid 12 will rise in the tube 2. This means that the weight of the package 30 can be found by reading off, against a mark 18, how high the coloured liquid 12 has risen in the tube 2.

Within the scope of the present invention the cavity 6, 2, formed in this embodiment by bladder 6 and tube 2, need not necessarily be closed. If the cavity is open, the weakened part 3 and the bladder 6 are suitably made of an elastically deformable material. The material then tries to regain its unloaded condition. This is to allow the force-transmitting element 19 to return to its original position or shape or orientation after the package has been picked up, which also means that the coloured liquid 12 will return to its original position, which is read against the marker as zero weight when the package is not picked up.

FIG. 3A-3D show in sequence how the handle is brought down through the top 9. First, the second wing 4B passes through an opening 11 in the top 9. Then the underside of the first wing 4A thrusts against the top side of the top 9 and turns clockwise about the weakened part 3 until the first wing 4A is entirely through the opening 11. For this embodiment, the weakened part 3 is sufficiently resilient (but not so as to have any significant influence when the package is being weighed in the handle) to turn the first wing 4A anticlockwise, when the wing 4A is entirely through the opening 11, enough so that the handle cannot be pulled out through the opening 11, see FIG. 3D. If the weakening 3 is not resilient, then the first wing 4A will still turn by gravity to its original position, while surface 5 of the second wing 4B stays in contact with the bladder 6.

### Modified Variants of the Embodiment Described Above

Within the scope of the present invention, the force-transmitting element 19 can have any given shape, and be arranged/oriented in any given way, as long as the idea of the invention is fulfilled. Examples of orientation, shape and number of force-transmitting elements:

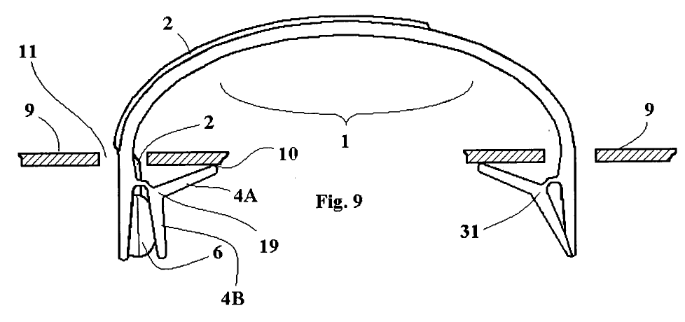

FIG. 9 shows an example of how the force-transmitting element 19 is shaped and oriented. In FIG. 9, the first wing 4A, being part of element 19, is in contact 10 with the top 9. Element 19 is oriented here that that the first wing 4A points toward the centre of the top 9.

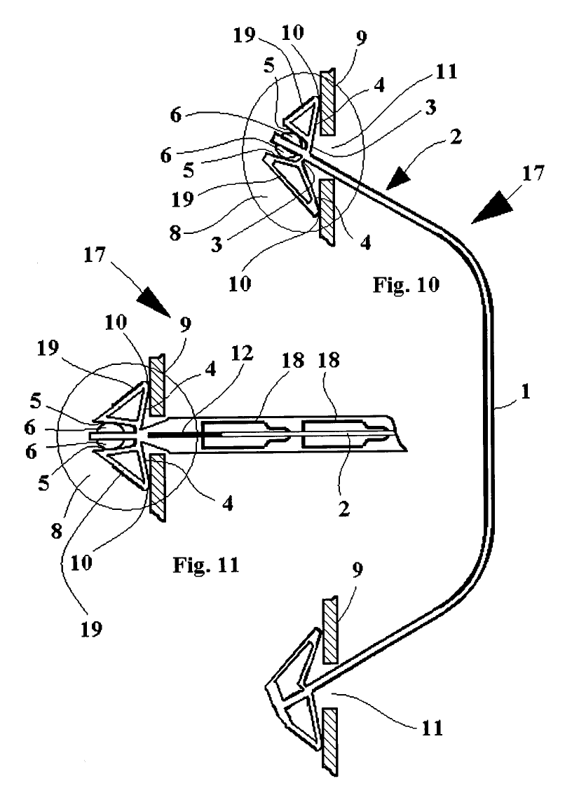

FIG. 10 shows a handle with two force-transmitting elements 19. They are oriented so that, when they turn, they do so in a cross section along the long side of the bag-in-box package.

FIG. 11 shows a cross section along the short side of the bag-in-box package, plus two force-transmitting elements 19 oriented so as to turn in this cross section when the package is picked up.

### A SECOND PREFERRED EMBODIMENT

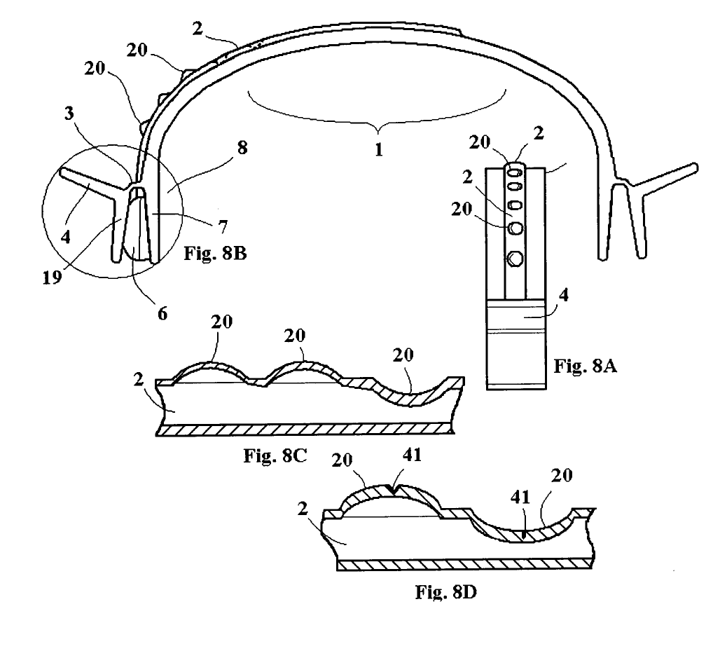

FIG. 8A-8C show a handle with bladder 6 and tube 2, forming a closed cavity. The cavity 6, 2 contains no coloured liquid in this embodiment, but instead only a gas, suitably air. The tube 2 is provided with a number of bubbles 20, arranged at a spacing in the lengthways direction of the tube 2. When the pressure in the bladder 6 and tube 2 corresponds to that which occurs if an empty package is picked up, all the bubbles 20 are in their retracted position. When the pressure rises, first the bubble 20 closest to the bladder 6 switches to its expanded position. As the pressure further rises, the second bubble 20 also switches, and so on.

FIG. 8C shows a section of tube 2 with three bubbles 20 of different thickness, two being expanded and one retracted.

FIG. 8D shows a section of tube 2 with two bubbles 20. At the middle of each bubble is a coloured depression 41. One bubble is retracted and conceals the colour, the other bubble is expanded and exposes the colour 41.

Bubbles 20 are formed from the wall of the tube 2. The bubbles can assume two positions, a retracted and an expanded position. A bubble is adapted so that, when the pressure in the cavity is below a certain value, it is in its retracted position, and when the pressure exceeds this value it is in its expanded position. In 8A and 8B, the bubbles 20 are placed in a row along the tube 2, and along the top side of the handle. A bubble 20 is conveniently adjusted by adapting its thickness, see FIG. 8C, so that it changes between its two positions at a given pressure. The bubbles 20 are adapted so that the bubble closest to the top 9 changes to its expanded position at a lower pressure than each succeeding bubble. The same holds for each succeeding bubble, except the last, placed furthest from the first bubble. Thus, for this embodiment, the adjustment is done by adapting the thickness of the bubbles, but in the scope of the present invention it could be done in any desired manner, e.g., by adapting the shape or material of the bubbles, instead of their thickness.

The weight of the package and thus the remaining quantity of liquid is read off by visual inspection or by feeling with the finger how many bubbles 20 are in their expanded position.

FIG. 8D shows a depression 41 in the bubbles 20. For an expanded bubble 20, the depression 41 is exposed, which exposes the colour applied to the depression. The weight of the package is determined by reading the number of exposed colour fields. Within the scope of the invention, any desired number of depressions can be applied to a bubble 20.

Note: There are substances which take on different colours at different pressures. Such a substance can be applied to a bubble, or be placed in a space made in the flexing part of the bubble. Since the bubbles flex between the two positions at different pressure of the cavity 6, 2, the volume of the space will change at different weights of the package. This means that the material can be made to change colour when the bubbles switch from a retracted to an expanded position, as the pressure in the space will change and exceed the pressure at which the material changes its colour. One can also consider creating such spaces in another way, with the volume of the spaces changing at different pressure in the cavity 6, 2.

### A THIRD PREFERRED EMBODIMENT

FIGS. 16A and 16B show a bubble 20. This bubble does not switch distinctly from a retracted to an expanded position, as in the previously described embodiment. Instead, the bubble 20 can assume any desired position between the two, as shown in FIGS. 16A and 16B. The bubble is adjusted so this nondistinct position depends on the pressure in the cavity 6, 2 and thus the weight of the bag-in-box package. A pointer 50 is placed on the bubble 20. The angle of the pointer 50 depends on the position of the bubble, which can be read off by sight against the marking 18.

### A FOURTH PREFERRED EMBODIMENT

Instead of making the cavity as a separate bladder 6 and tube 2 attached to the handle, the cavity in the scope of the present invention can be made directly in the handle. FIGS. 14A and 14B show a cross section of a weighing handle. The handle here is injection-moulded as a single piece, containing a cavity 6 and tube 2.

### A FIFTH EMBODIMENT

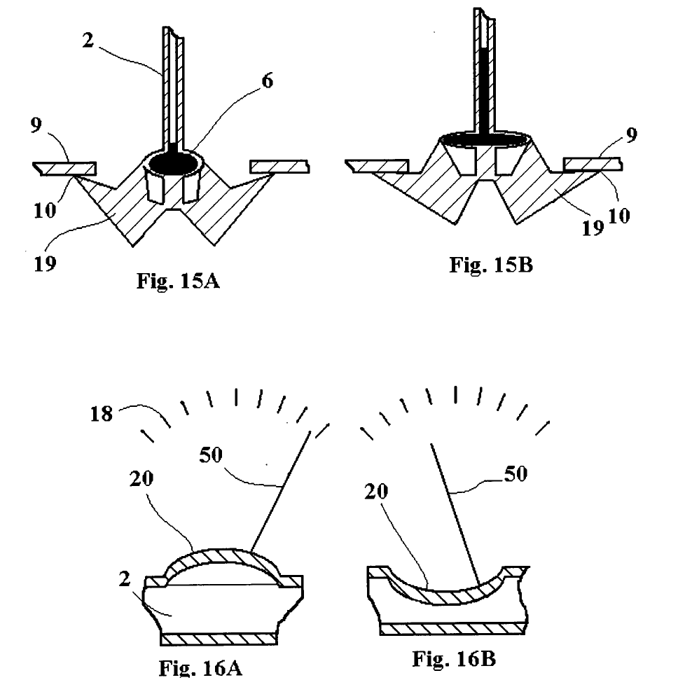

FIGS. 15A and 15B show an embodiment where the cavity 6, 2 is arranged so the force-transmitting element 19 stretches out the cavity. In this process, the liquid rises in the tube 2.

### NOTES AND DEFINITIONS OF TERMS

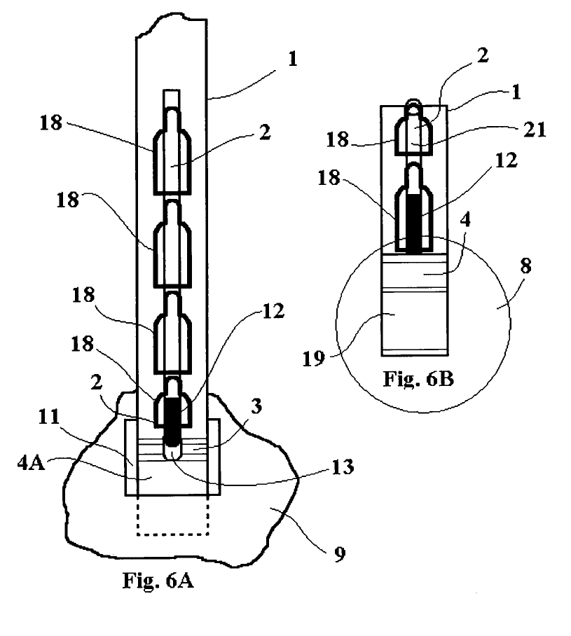

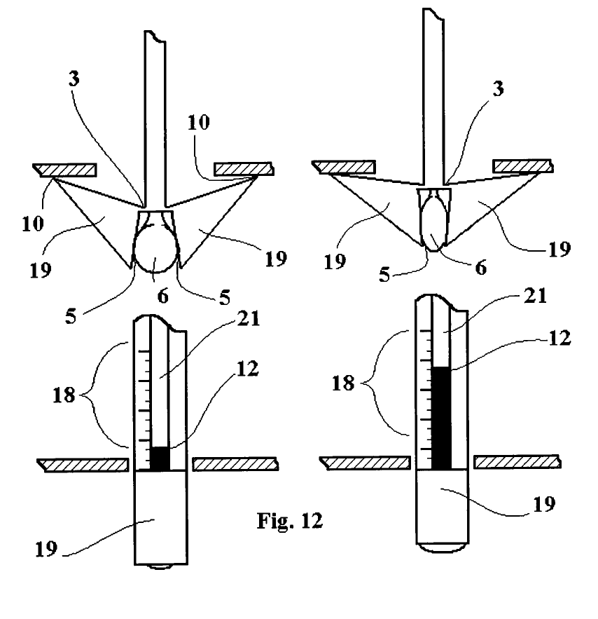

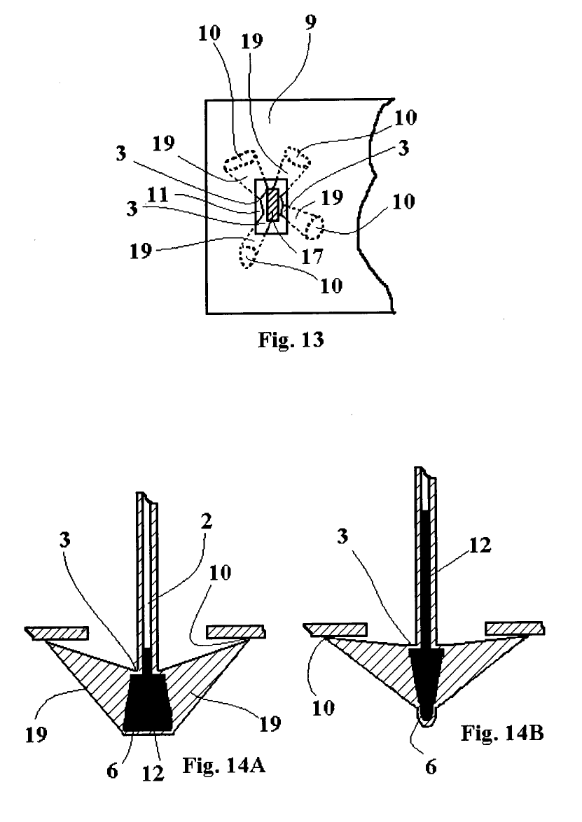

A bag-in-box package 30 means here a package comprising a rigid outer shell 15, a flexible inner bag 14, and a tap 16 from which liquid can be drained, see FIG. 5. A marking is conveniently placed on the handle 17. The marking 18 can have any desired appearance. Examples of markings are lines, see FIG. 12, or bottles, see FIGS. 6 and 11. One field of application of bag-in-box packages is to be filled with wine. The usual quantity is 3 litres, corresponding to four 75-centiliter wine bottles. A convenient number of bottles to mark the handle with is four units.

FIG. 3 shows how the handle 17, and especially section 8, is led through the opening 11 below the top 9 of the bag-in-box package. The handle is secured to the top in two places. The fastening where the bladder is not located is advisedly produced in similar fashion to the fastening where the bladder 6 is located. For example, see FIG. 9, where the handle is secured in the top by leading it down through the openings in the top 9. The piece 31 bends clockwise and then anticlockwise and when it is entirely through the top 9 it rights itself and locks the handle in the top.

Note that the force-transmitting element 19 can be in any given number, they can be distributed arbitrarily about the opening 11, and they can be applied to the handle at one or both of its fastenings.

The cavity 6, 2 in the scope of the present invention can be constituted of a bladder/tube 6, 2 applied to the handle 17, but likewise the cavity in the scope of the present invention can be located in the handle itself, see FIGS. 14a and 14B, and have any given shape, as long as its deformation in a certain sense can be translated into the weight of the package, which can be translated into the remaining quantity of liquid or the quantity drained out.

Note that the tube 2 is suitably made of a transparent or translucent material, so that a fluid 12 contained in the tube allows one to determine the weight of the package by visual inspection.

Note that the joint 3 in the drawings consists of a weakening, but within the scope of the present invention it can also be a hinge joint, or another joint allowing the force-transmitting element 19 to move in a way characteristic of the invention when the package is lifted.

Note that the piece (body) in which the cavity is situated can be applied to the handle or be made up from a part or parts of the handle, or consist of the entire handle.

Note that at least one part of the piece 6, 2 in which the cavity is situated is made of a deformable material. Advisedly, but not necessarily, of an elastically deformable material. Elastically deformable means that the material tends to return to its original shape. By original shape is meant here the shape or appearance of the handle, plus all the parts, when the package is not picked up. Basically, this original shape will not change when the invention is applied, i.e., the original shape is the same shape which the handle has before it is applied, which coincides with the shape the handle has when the package is not picked up.

By original orientation is meant the relative orientation of the parts making up the handle when the handle is not lifting a package. Basically, this original orientation will not change when the invention is applied.

For the first embodiment, see for example FIGS. 7A and 7B, the air 21 in the tube is compressed when the package is lifted. When the handle ceases to be lifted, this pressure increase strives to return the handle to its original shape.

For the first preferred embodiment and when the bag-in-box package is being weighed, the coloured liquid 12 moves into part of the cavity which is occupied by air 21 when the package is not being lifted. The volume of the cavity h which the liquid moves into and occupies during the weighing (but does not occupy it when the package is not being weighed) depends on the weight of the package, yet the dependency is not linear. For a straight tube, the rise s of liquid in the tube is a linear function of h; s(h)=kh. This means that the rise of liquid s is not a linear function of the package weight when the tube is straight. On the other hand, one sees that k is only a constant if the tube is straight. Take a tube whose cross sectional area A depends on s; A(s). A function A can thus be found that makes s depend approximately as a linear function of the package weight.

FIGS. 15A and 15B show how the bladder 6 is deformed by the force-transmitting element 19 when the package is lifted, which decreases the volume of the bladder 6 so that the coloured liquid rises in the tube 2.

1. Handle (17) adapted for fastening to a package (15), characterised in that the handle (17) runs through at least one opening (11) in the top (9) of the package, that the underside of the top forms at least one contact surface (10) with at least one force-transmitting means (19), that the means (19) is attached to or constituted by the handle, that when the package is lifted the means (19) is arranged so that it transmits the package weight via the top to a piece (6; 2) in which a cavity (6; 2) is situated, that the cavity (6; 2) thereby changes its shape and that the change in shape allows the remaining package content or the removed content to be read off directly or indirectly.

2. Handle according to claim 1, characterised in that the force-transmitting means (19) is given a shape and arranged so that each part of the means (19) located closer to the opening (11) than the contact surface (10) moves upward when the package is lifted.

3. Handle according to claim 1, characterised in that the force-transmitting means (19) is applied to the handle via a joint (3), that one surface (5) of the force-transmitting element (19) lies against at least one part of at least one piece (6, 2) in which a cavity is located, that the force-transmitting element (19) turns about the joint (3) when the package is lifted, that the cavity changes shape due to the surface (5) increasing its pressure on the cavity (6, 2) when the turning occurs.

4. Handle according to claim 1, characterised in that the piece (6, 2) in which the cavity is located is a bladder (6) connected to a tube (2).

5. Handle according to claim 4, characterised in that the bladder (6) is located beneath the top (9), and that the tube (2) runs from the bladder (6) up through the opening (11) and alongside the handle (17).

6. Handle according to claim 1, characterised in that the cavity (6; 2) contains a fluid (12).

7. Handle according to claim 6, characterised in that the fluid (12) rises in the tube (2) when the package (15) is lifted.

8. Handle according to claim 7, characterised in that the package weight is read by visually reading the level of the fluid (12) against a marking (18).

9. Handle according to claim 1, characterised in that the cavity (6; 2) is closed.

10. Handle according to claim 9, characterised in that the walls of the cavity comprise at least one bubble (20), that the bubble can assume a retracted and an expanded position, that the bubble is adapted so that it is retracted when the pressure in the cavity is below a certain value, and expanded when the pressure in the cavity is above this value.

11. Handle according to claim 9, characterised in that the cavity (6; 2) decreases when the package is picked up, that the resulting pressure increase tends to restore the cavity and thus the handle (17) and the piece (6; 2) and the force-transmitting element (19) to the original orientations and original shapes.

12. Handle according to claim 1, characterised in that the elastic material deformation occurring when the package is picked up tends to restore the cavity and thus the handle and the piece (6; 2) and the force-transmitting element (19) to the original orientations and original shapes.

13. Handle according to claim 1, characterised in that the package is a bag-in-box package and the contents of the package are a fluid.

14. Handle according to claim 1, characterised in that the force-transmitting element (19) is adapted so that it turns when it is led down through the opening (11) in the top of the package and then it turns back underneath the top.

15. Handle according to claim 2, characterised in that the force-transmitting means (19) is applied to the handle via a joint (3), that one surface (5) of the force-transmitting element (19) lies against at least one part of at least one piece (6, 2) in which a cavity is located, that the force-transmitting element (19) turns about the joint (3) when the package is lifted, that the cavity changes shape due to the surface (5) increasing its pressure on the cavity (6, 2) when the turning occurs.

16. Handle according to claim 2, characterised in that the piece (6, 2) in which the cavity is located is a bladder (6) connected to a tube (2).

17. Handle according to claim 3, characterised in that the piece (6, 2) in which the cavity is located is a bladder (6) connected to a tube (2).

18. Handle according to claim 2, characterised in that the cavity (6; 2) contains a fluid (12).
